(19) United States
(12) Patent Application Publication
(10) Pub. No.: US 2019/0221881 A1
(43) Pub. Date: Jul. 18, 2019

(54) METHOD FOR MANUFACTURING LITHIUM SECONDARY BATTERY

(71) Applicant: LG CHEM, LTD., Seoul (KR)

(72) Inventors: Min-Kyu YOU, Daejeon (KR); Sung-Joong KANG, Daejeon (KR); Ju-Ryoun KIM, Daejeon (KR); In-Sung UHM, Daejeon (KR)

(73) Assignee: LG CHEM, LTD., Seoul (KR)

(21) Appl. No.: 16/336,595

(22) PCT Filed: Mar. 8, 2018
(86) PCT No.: PCT/KR2018/002789

§ 371 Date: Mar. 26, 2019

(30) Foreign Application Priority Data
Apr. 6, 2017 (KR) 10-2017-0044955

(51) Int. Cl. H01M 10/058; H01M 10/052; H01M 2/02; H01M 4/76; H01M 10/04

(52) U.S. Cl. CPC H01M 10/058; H01M 10/052; H01M 10/0481; H01M 4/762; H01M 2/0285

(57) ABSTRACT

A method for manufacturing a lithium secondary battery including (S1) providing a battery frame including a battery casing, the battery casing including a first side and a second side, the first side including a three-dimensional porous positive electrode current collector and the second side including a three-dimensional porous negative electrode current collector; (S2) introducing a positive electrode active material to the pores formed in the positive electrode current collector, and introducing a negative electrode active material to the pores formed in the negative electrode current collector; and (S3) pressing the battery casing to deform the battery casing into a predetermined shape.

### TECHNICAL FIELD

The present disclosure relates to a method for manufacturing a lithium secondary battery. More particularly, the present disclosure relates to a method for manufacturing a lithium secondary battery which can produce a battery by introducing an electrode active material into the pores of a three-dimensional porous current collector provided in a battery casing and then pressing the battery casing, and thus requires no separate process for manufacturing an electrode.

The present application claims priority to Korean Patent Application No. 10-2017-0044955 filed on Apr. 6, 2017 in the Republic of Korea, the disclosures of which are incorporated herein by reference.

### BACKGROUND ART

A lithium secondary battery having high applicability to various groups of products and high electrical properties, such as energy density, has been used generally not only in portable instruments but also for electric vehicles (EV) or hybrid vehicles (HV) driven by an electrical driving source.

Such a lithium secondary battery has a primary advantage of significantly reducing the use of fossil fuel, and has been given many attentions as a novel energy source for improving eco-friendly characteristics and energy efficiency in that it generates no byproduct after the use of energy.

A lithium secondary battery is a device in which a positive electrode and a negative electrode electrically react with each other to generate electricity. Such secondary batteries may be classified into stacked structures, wound structures (jelly roll-type structures) or stacked/folded structures, depending on the structure of an electrode assembly.

Among them, an electrode assembly having a stacked structure is formed by cutting a preliminarily formed positive electrode, a preliminarily formed separator and a preliminarily formed negative electrode to a predetermined size and stacking them successively. Herein, each separator is disposed between a positive electrode and a negative electrode.

Meanwhile, although demand of lithium secondary batteries has been increased recently by virtue of high capacity, high output and low cost, there is a limitation in the conventional processes for manufacturing the batteries. Particularly, it is required to increase the loading amount of an electrode active material and to reduce the number of electrode assembly stacks in order to realize high capacity and low cost. However, due to the processing problems related therewith, some phenomena including an imbalance in loading amount of an electrode active material and defects in processing an electrode, such as low adhesion of an electrode active material layer, may be generated. Particularly, due to an increase in distance between a current collector and an electrode active material layer, there is a problem in that the output characteristics of a battery are degraded rapidly.

### DISCLOSURE

### Technical Problem

The present disclosure is designed to solve the problems generated in the process for manufacturing a high-capacity electrode according the related art, and therefore the present disclosure is directed to providing a method for manufacturing a lithium secondary battery which avoids a need for a separate process for manufacturing an electrode required essentially in the conventional process for manufacturing a battery.

### Technical Solution

In one aspect of the present disclosure, there is provided a method for manufacturing a lithium secondary battery which includes the steps of: (S1) providing a battery frame including a battery casing, the battery casing including a first side and a second side, the first side including a three-dimensional porous positive electrode current collector and the second side including a three-dimensional porous negative electrode current collector; (S2) introducing a positive electrode active material to the pores formed in the positive electrode current collector, and introducing a negative electrode active material to the pores formed in the negative electrode current collector; and (S3) pressing the battery casing to deform the battery casing into a predetermined shape.

Herein, in step S1, the battery frame may further include a separator interposed between the positive electrode current collector and the negative electrode current collector.

In addition, the battery casing may be an aluminum pouch or aluminum can.

In addition, each of the positive electrode current collector and the negative electrode current collector may have any one form selected from the porous structures composed of metallic foam, metallic mesh and metallic fibers.

Meanwhile, step S2 may be carried out under vacuum.

In addition, in step S2, the positive electrode current collector and the negative electrode current collector may be vibrated.

In addition, in step S2, each of the positive electrode active material and the negative electrode active material may be introduced in the form of slurry or in the form of a dry active material coated with a binder.

Meanwhile, step S3 may be carried out together with a step of drying the introduced positive electrode active material and the introduced negative electrode active material.

Meanwhile, the lithium secondary battery may be a solid state battery.

### Advantageous Effects

According to an embodiment of the present disclosure, an electrode active material is introduced into the pores of a three-dimensional porous current collector provided in a battery casing and then the battery casing is pressed to obtain a battery. Therefore, there is no need for a separate process for manufacturing an electrode, thereby simplifying a process for manufacturing a battery.

In addition, since the three-dimensional porous current collector functions as a support which supports the active material, it is possible to overcome the structural limit of an electrode according to the related art, and to obtain a battery having a single stack of electrode assembly, not a plurality of electrode assembly stacks.

Further, according to the present disclosure, it is possible to reduce the amount of a binder used for the electrode active material.

### DESCRIPTION OF DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawing.

FIG. 1 is a schematic view illustrating introduction of each electrode active material to a three-dimensional porous electrode current collector according to an embodiment of the present disclosure.

FIG. 2 is a schematic view illustrating a step of pressurizing a battery frame to carry out pressing according to an embodiment of the present disclosure.

### DESCRIPTION OF DRAWING NUMERALS

1: Battery frame
10: Porous positive electrode current collector
11: Positive electrode active material
20: Porous negative electrode current collector
21: Negative electrode active material
30: Separator
100: Battery casing

### BEST MODE

Hereinafter, preferred embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation.

Therefore, the description proposed herein is just a preferable example for the purpose of illustrations only, not intended to limit the scope of the disclosure, so it should be understood that other equivalents and modifications could be made thereto without departing from the scope of the disclosure.

Hereinafter, the method for manufacturing a lithium secondary battery according to the present disclosure will be explained.

First, a battery frame includes a battery casing 100, the battery casing 100 includes a first side and a second side, the first side includes a three-dimensional porous positive electrode current collector 10 and the second side includes a three-dimensional porous negative electrode current collector 20, (step S1).

Herein, the battery casing 100 functions as a casing material for the subsequently manufactured battery and may be a currently used aluminum pouch or aluminum can.

Herein, the inner surface of the battery casing 100 may be coated with a coating layer including an insulator material.

In addition, the battery frame 1 may further include a separator 30 interposed between the positive electrode current collector 10 and the negative electrode current collector 20 to prevent a short-circuit between the positive electrode and the negative electrode.

Meanwhile, each of the three-dimensional porous positive electrode current collector 10 and negative electrode current collector 20 may have any one form selected from the porous structures composed of metallic foam, metallic mesh and metallic fibers.

Herein, the porous electrode current collector has pores formed therein, and the electrode current collector may have a porosity of 15-50%, preferably 20-40%. By virtue of such a range of porosity, the pores are filled with an adequate amount of electrode active material to increase the contact area between the electrode active material and the current collector, thereby providing a battery with improved electroconductivity, increased loading amount and reduced resistance.

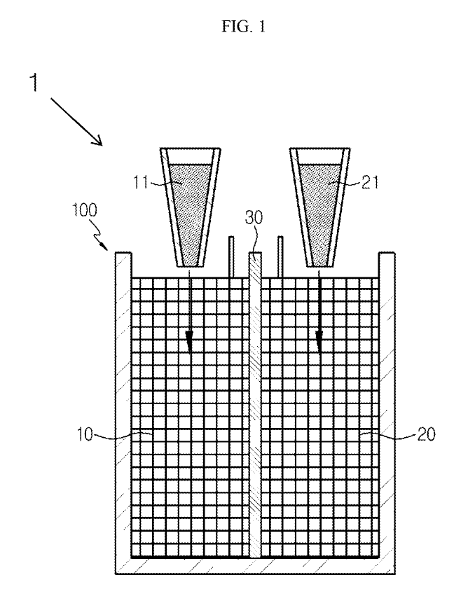

Next, a positive electrode active material 11 is introduced to the pores formed in the positive electrode current collector 10 and a negative electrode active material 21 is introduced to the pores formed in the negative electrode current collector 20 (step S2). FIG. 1 shows step S2 schematically.

Herein, step S2 may be carried out under vacuum, and the positive electrode current collector and the negative electrode current collector may be vibrated. Thus, it is possible to inject the electrode active materials more easily to the pores formed in the porous positive electrode current collector 10 and negative electrode current collector 20.

Meanwhile, in step S2, each of the positive electrode active material 11 and the negative electrode active material 21 may be introduced in the form of slurry or in the form of a dry active material coated with a binder. When each electrode active material is introduced in the form of a dry active material, it is possible to dry the electrode more easily as compared to the electrode active material introduced in the form of slurry.

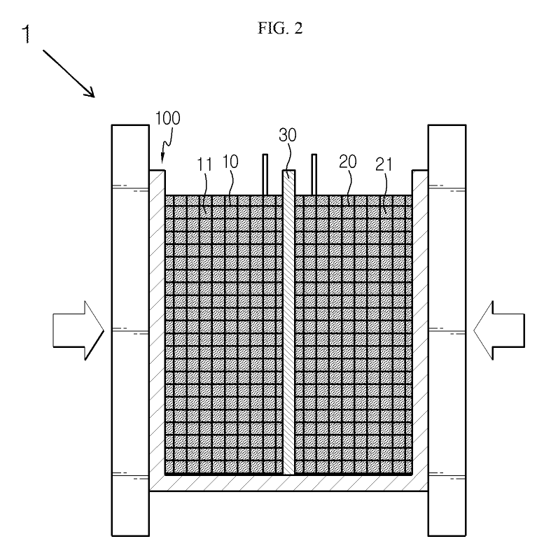

Then, the battery frame 1 is pressed to deform the battery casing into a predetermined shape (step S3). FIG. 2 shows step S3 schematically.

Through this step, the positive electrode and the negative electrode are finished in the battery frame 1 so that they may function as electrodes. In addition, the positive electrode and the negative electrode are formed to be in close contact with each other with a separator interposed therebetween, and thus lithium ion transport between both electrodes may be facilitated.

Herein, step S3 may be carried out by further heating the battery frame 1 so that a step of drying the introduced positive electrode active material and the introduced negative electrode active material may be performed together.

In addition, similarly to step S2, step S3 may be carried out under vacuum and the battery frame 1 may be vibrated. Thus, it is possible to introduce the electrode active materials to the pores formed in the porous positive electrode current collector and negative electrode current collector more easily.

By virtue of the pressing step, it is possible to fabricate a battery to have a desired shape.

After step S3, an electrolyte, such as a non-aqueous electrolyte, is injected to the battery frame 1 to finish a battery. Further, the above-mentioned process may be used as a process for manufacturing a solid state battery, particularly an inorganic solid state battery, besides a conventional lithium secondary battery using a non-aqueous electrolyte.

Herein, the method for manufacturing a solid state battery will be explained in more detail. A solid electrolyte may be added to an electrode active material slurry during the step of forming the slurry, and then the slurry may be introduced to a current collector to obtain a battery. In a variant, an electrode active material may be coated with a solid electrolyte, a dry electrode active material may be introduced to a current collector, and then heat treatment may be carried out to obtain a battery.

According to an embodiment of the present disclosure, it is possible to avoid a need for a separate process for manufacturing an electrode, which, otherwise, is essentially required for the conventional process for manufacturing a battery. Thus, it is possible to simplify a process for manufacturing a battery. Further, since the process for manufacturing an electrode is eliminated, it is possible to solvent the problems, such as an imbalance in loading amount of an electrode active material and low adhesion of an electrode active material layer, generated in the process for manufacturing a high-capacity electrode according the related art.

In addition, it is possible to overcome a structural limit of an electrode by using a three-dimensional porous current collector, and thus to obtain a battery having a single stack of electrode assembly, not a plurality of electrode assembly stacks.

Particularly, since the method according to the present disclosure uses a three-dimensional porous current collector, it is possible to reduce the amount of a binder used for the electrode active material. Further, even when using no binder, the porous current collector may function as a support for the electrode active material so that the electrode active material may be fixed in the pores of the porous current collector.

The present disclosure has been described in detail. However, it should be understood that the detailed description and specific examples are given by way of illustration only, since various changes and modifications within the scope of the disclosure will become apparent to those skilled in the art from this detailed description. Therefore, the embodiments disclosed herein are for illustrative purposes only and the scope of the present disclosure is not limited thereto. The scope of the present disclosure is defined by the following claims and it should be understood that other changes and modifications made within the equivalents thereof are also included in the scope of the present disclosure.

1. A method for manufacturing a lithium secondary battery, comprising:
(S1) providing a battery frame comprising a battery casing, the battery casing including a first side and a second side, the first side including a three-dimensional porous positive electrode current collector and the second side including a three-dimensional porous negative electrode current collector;
(S2) introducing a positive electrode active material to the pores formed in the positive electrode current collector, and introducing a negative electrode active material to the pores formed in the negative electrode current collector; and
(S3) pressing the battery casing to deform the battery casing into a predetermined shape.

2. The method for manufacturing a lithium secondary battery according to claim 1, wherein the battery frame further comprises a separator interposed between the positive electrode current collector and the negative electrode current collector.

3. The method for manufacturing a lithium secondary battery according to claim 1, wherein the battery casing is an aluminum pouch or aluminum can.

4. The method for manufacturing a lithium secondary battery according to claim 1, wherein each of the positive electrode current collector and the negative electrode current collector has any one form selected from the porous structures of metallic foam, metallic mesh or metallic fibers.

5. The method for manufacturing a lithium secondary battery according to claim 1, wherein step S2 is carried out under vacuum.

6. The method for manufacturing a lithium secondary battery according to claim 1, wherein the positive electrode current collector and the negative electrode current collector are vibrated, in step S2.

7. The method for manufacturing a lithium secondary battery according to claim 1, wherein each of the positive electrode active material and the negative electrode active material is introduced in the form of slurry or in the form of a dry active material coated with a binder, in step S2.

8. The method for manufacturing a lithium secondary battery according to claim 1, wherein step S3 is carried out together with a step of drying the introduced positive electrode active material and the introduced negative electrode active material.

9. The method for manufacturing a lithium secondary battery according to claim 1, wherein the lithium secondary battery is a solid state battery.
